(19) United States
(12) Patent Application Publication
(10) Pub. No.: US 2007/0099015 A1
(43) Pub. Date: May 3, 2007

(54) Composite sliding surfaces for sliding members

(76) Inventors: Lloyd Kamo, Columbus, IN (US); Walter Bryzik, Grosse Point, MI (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/521,950

(22) Filed: Sep. 15, 2006

Related U.S. Application Data
(60) Provisional application No. 60/718,100, filed on Sep. 15, 2005.

(51) Int. Cl. B05D 7/00; B05D 3/02; B32B 15/04

(52) U.S. Cl. 428/469; 427/212; 427/372.2

(57) ABSTRACT

A composite sliding layer is formed on a wear surface, such as on piston ring and/or cylinder bore, from a powder mixture containing iron oxide and iron titanate. The resulting coating is hard and durable and reduces losses due to friction and wear.

### RELATED APPLICATION DATA

This application claims the benefit of U.S. Provisional Application Ser. No. 60/718,100 filed Sep. 15, 2005 under attorney docket number 690064.

### GOVERNMENT RIGHTS

This invention was made with government support under Contract Number DAAE07-02—C-L007 awarded by the Army. The U.S. Government has certain rights in the invention.

### BACKGROUND

The present invention is generally related to coatings for sliding surfaces, and more particularly, but not exclusively, is related to composite coatings for sliding members, such as piston rings and/or cylinder liners, that improve the friction and/or wear characteristics of the sliding surfaces.

Friction and wear are the enemies of efficiency and durability. It is well known that composite materials, such as ceramics and cermets, have the potential to provide desirable friction and wear characteristics when used as a coating on a sliding surface. However, high raw material and manufacturing costs and the difficulty in forming suitable coating layers have been barriers to the commercial application of composites on many sliding surfaces, particularly on piston rings and cylinder liners. The present invention is directed to addressing this need by providing a composite coating that has low raw material cost and can easily be applied to a variety of surfaces.

Applicant's prior laboratory work directed towards developing tribological surface coatings for low heat rejection (LHR) high output diesel engines evaluated composite coatings formed from the post treatment densification of plasma sprayed coatings. (Kamo, et al. High Temperature Tribological Coatings for Advanced Military Diesel Engines, SAE Publication No. 970203, March 1997) The plasma sprayed coatings were based on either an iron oxide powder or what was referred to as iron oxide/titanium dioxide (Fe₂O₃/TiO₂). The post treatment densification was with chromic acid and chrome phosphate based liquid binders that infiltrate the interstitial spaces and, upon heating, convert to chrome oxide and a phosphate glass. However, despite promising results, none of the densified plasma sprayed coatings met all of the friction and wear target objectives for the study (i.e. for the specific LHR engine application) nor have they subsequently found commercial acceptance in other friction wear applications, the latter of which may be attributable to high production costs and difficulties in applying an adequate plasma spray of the base powder matrix onto piston rings or the corresponding surface of a cylinder bore.

Applicants have now discovered that use of mixtures of iron oxide and iron titanate powders in a composite coating can yield desirable friction and wear characteristics. Surprisingly, Applicants have also discovered that, in some cases, such mixture based composite coatings can achieve more desireable tribological properties than comparable coatings of either iron oxide or iron titanate alone. Composite coatings based on an iron oxide/titanate mixture may be applied in a number of ways to existing piston and cylinder liner systems, and it is believed that these application techniques will avoid the problems and/or high costs of plasma spray application. Moreover, it appears that the adjustment of the relative ratio of oxide to titanate can be used to adjust the friction and wear characteristics of the coating, thereby providing an enhanced ability to create composite coatings tailored for a particular application, such as for a particular ring/liner combination or for a particular liquid lubricant (or lack thereof) to be used. These and other aspects are discussed more fully below.

### SUMMARY

The present invention provides coatings for wear surfaces, such as bearings, turbines, propeller blades, and the piston rings (e.g. sealing rings) and/or cylinder liners of water pumps, air compressors or internal combustion engines, which coatings serve to reduce the friction loss and/or wear of the sliding contact surfaces. While the actual nature of the invention covered herein can only be determined with reference to the claims appended hereto, certain aspects of the invention that are characteristic of the embodiments disclosed herein are described briefly as follows.

According to one aspect, a piston ring and/or cylinder bore includes a composite sliding surface layer on a substrate wherein the solids in the composite layer include a mixture of the oxides and titanates of iron in a ratio from 1:6 and 3:1, iron oxide to iron titanate by weight. Other solids in the composite layer may include other metallic oxides, ceramic fillers, and powdered metals or metal alloys, and all of the solids may be in the form of discrete, finely divided particles (e.g. less than −325 mesh). In typical applications, iron oxide and iron titanate together will constitute at least about 25% of the total solids in the composite layer, and in certain coatings, may constitute at least 30, 40, 50, 60, 70, 80, or 90% of the total solids by weight.

The base substrate may be any ferrous or non-ferrous material suitable for use in piston ring/cylinder liner applications, such as iron, stainless steel, aluminum, titanium, high temperature polymers, carbon composite, or glass. Typically a piston ring or cylinder bore (the inner surface of cylinder against which the piston ring travels) will be steel, aluminum or ductile iron.

The composite layer may be formed on the substrate in a variety of ways, including via a sol-gel process, an electro deposition process (e.g. micro-plasma oxidation, anodizing, metal plating), a cladding process (e.g. laser cladding), and an alloying process (e.g. laser alloying). In sol-gel processing, a liquid binder may be used both to apply a powder slurry to the part and to produce, upon activation, a glass phase surrounding the solid particles in the slurry. For others coating processes, a similar liquid binder may, if desired, be used as a densifier to infiltrate open porosity in the coating and provide a glass phase around the solids. Where a coating would have very little open porosity to fill, such as may be expected with plating, cladding and alloying type processes, subsequent densification would likely be of little benefit.

With a sol gel application process, the resulting composite sliding surface layer may include finely divided discrete particles of iron oxide, iron titanate and any filler materials in a glass phase, such as a phosphate glass. The particles may include about 10-70% by weight iron oxide, about 10-70% by weight iron titanate, about 5-50% by weight ceramic filler, and about 0-15% by weight powdered metal or alloy.

With an electrodeposition process, the resulting composite surface may be mostly iron oxide, iron titanate, and another metal oxide. For example, it is expected that microplasma oxidation of an powder mixture onto an aluminum substrate may result in a coating layer that is mostly aluminum oxide and the iron oxide/titanate mixture.

According to another aspect, a composite sliding surface layer is formed on a metal substrate by densifying a layer of solids applied to the substrate, wherein the solids comprise 10-80% by weight iron oxide and 10-80% by weight iron titanate. In one form, a mixture of the solids and a densifying liquid is formed and then the mixture is applied to the substrate in a sol-gel technique, such as via dip coating, spraying, brushing or other type of painting, such as low pressure high volume (LPHV) spray painting. In another form, a densifying liquid is applied to the substrate after the layer of solids is applied. In these and other forms, the densifying liquid is chosen such that curing is performed at a relatively low temperature, such as, below about 250° C.

Accordingly to another aspect, a sliding member having a composite sliding surface layer is provided. The composite sliding surface layer comprises iron oxide, iron titantate and a phosphate glass, wherein the ratio of iron oxide to iron titanate by weight is between about 1:6 and 3:1, more particularly between 1:6 and 1:1. In particular refinements, the composite sliding surface layer further comprises ceramic filler at a weight ratio to the combined weight of iron oxide and iron titanate of between about 1:10 and 1:3.

According to another aspect, a powder composition for use in creating a bearing surface is provided comprising about 10-70% by weight iron oxide, about 10-70% by weight iron titanate, and about 5-50% by weight ceramic filler. The composition may further comprise up to about 15% by weight metals or alloys. In a further refinement, the weight ratio of iron oxide to iron titanate is between 1:1 and 3:1.

According to another aspect, a finely divided discrete powder mixture for use in forming a composite sliding surface layer on a cylinder bore or piston ring is provided comprising iron oxide and iron titanate in a weight ratio of iron oxide to iron titanate from 1:6 to 3:1. This powder may be used by one or more of the coating techniques described herein to make a composite sliding surface layer on a piston ring or cylinder bore wherein the weight ratio of iron oxide to iron titanate in the sliding surface layer is between 1:3 and 2:1. The average particles size is preferably less than 40 μm, more preferably less than 20 μm.

According to another aspect, a composite coating for a wear surface includes at least 20% hematite and ilmenite in a ratio between 1:6 and 3:1, all by weight.

These and other aspects are discussed below.

### DESCRIPTION OF THE ILLUSTRATED EMBODIMENTS

For the purposes of promoting an understanding of the principles of the invention, reference will now be made to the specific embodiments and specific language will be used to describe the same. It will nevertheless be understood that no limitation of the scope of the invention is hereby intended. Alterations and further modifications of these specific embodiments and further applications of the principles of the invention as illustrated herein are contemplated as would normally occur to one skilled in the art to which the invention relates.

On embodiment of the present invention comprises a coating that can be applied to sealing rings and/or cylinder liners for any application where a sealing ring will slide against a smooth cylinder liner surface. The coating can be applied to a piston seal ring, a cylinder bore surface or both the piston seal ring and the cylinder bore surface. The coating can serve to improve the friction, wear, and/or performance characteristics of the engine, compressor or pump that it lines or protects alone or in conjunction with a liquid lubricant, such as an SAE/API designated lube oil (e.g. for internal combustion engines) or water (e.g. for water pumps).

The coating can be applied by a sol-gel process wherein a finely divided powder is mixed with a liquid binder. The resulting slurry is applied to the part and heat cured to form a composite coating. The process of applying a slurry and heat curing can be repeated until a desired coating thickness is achieved. Typically, in such sol-gel type processes, the binder is thermally activated to generate a chemical bond between the powder constituents of the coating and between the coating and the substrate.

The primary components of the powder are a mixture of iron oxide (e.g. Fe₂O₃ or Fe₃O₄) and iron titanate (e.g. FeTiO₃, sometimes referenced as Fe⁺²TiO₃). Various forms of iron oxide powders may be used, including hematite and magnetite. Hematite is the rust like form of iron oxide and corresponds to Fe₂O₃, whereas magnatite is a black powder form of iron oxide and corresponds to Fe₃O₄. In certain applications, most or all of the iron oxide is the hematite form. The iron titanate powder is preferably ilmenite, sometimes referred to as iron-titanium oxide.

Various ratios of iron oxide to iron titantate can be employed. Typically the ratio of iron oxide to iron titanate by weight in the powder will be between about 1:6 and 3:1, for example 1:5,1:4,1:3,1:2,1:1, 1.5:1, 2:1, 2.5:1 or ranges therebetween. Varying the ratio of these powders can be used to tailor the friction/wear characteristics of the coating. For example, for certain coatings, it has been observed that increased levels of iron titanate correlate to decreased friction coefficient and that increased levels of iron oxide correlate to reduction in wear.

The powder may also include minor amounts of other metallic oxides, other ceramic fillers and/or metallic particles (such as steel powder). During sol-gel processing, the ceramic fillers may be used to control the flowability of the slurry so as to aid application of the slurry to the part. Ceramic fillers may also be included for their thermal efficiency, for example to increase the increase heat transfer resistance of the resultant ceramic coating. Suitable ceramic fillers include zirconium dioxide (e.g. calcium stabilized), aluminum oxide, silicon dioxide, titanium dioxide. In typical sol-gel formulations, these minor constituents will be less than 50% of the powder, for example less than 45%, less than 40%, less than 35%, less than 30%, less than 25%, less than 20%, or less than 15% by weight of the powder.

In a sol-gel application technique, a liquid binder is added to the powder. The liquid binder is used to create the slurry as an aid for application of the powder. Then, after a slurry coating has been applied to the substrate, the coating is densified. Separate liquids may be used as the binder and densifier, in which case the coating is dried to burn off the binder prior to application of a densfier and subsequent curing. To reduce processing steps, a densifier may be used as the liquid binder, such that densification can be performed without first burning off the binder. A useful liquid that may serves as both a binder and a densifier is a metallic phosphate or organometallic phosphate that cures into a phosphate glass.

As described more fully in U.S. Pat. No. 5,360,634 to Kamo, an organometallic phosphate binder may be prepared by first combining formic acid and chromic acid to form an organic chrome oxide solution. The formic acid is preferably added to a near saturated solution of chromic acid at a slow drop rate (e.g. 10 drops per minute) due to the strong exothermic nature of the resulting reaction, which typically results in vigorous boiling of the solution as it forms an intermediate organic chrome oxide solution. The formic acid may be provided in a solution, for example in a concentration ranging from 25% to 100%, but the ratio of non-diluted formic acid to chromic acid should be close to 1:1. If a diluted formic acid or chromic acid solution is used, the excess water may be boiled off during the exothermic reaction between the two acids or via external heating.

The final binder solution is then formulated by addition of a phosphorous source, for example phosphoric acid or monoaluminum phosphate, to the organic chrome oxide solution. A suitable technique is for 40% by volume of the formic/chromic acid solution (i.e. the intermediate organic chrome oxide solution) in a saturated state to be mixed with 60% of an 85% Technical Grade phosphoric acid. The resultant solution is an organomettalic phosphate, or more particularly an organic chrome phosphate, that has the capability to bind refractory metal oxides, carbides and nitrides to both ferrous and non-ferrous metals when heated to at least about 385° F. (196° C.).

The slurry is made by adding this organometallic phosphate to the powder. A suitable powder composition is 40% iron oxide, 30% iron titanate, 25% zirconium dioxide, and 5% steel powder, by weight. All powder constitutents can be less than 325 mesh. The ratio of liquid binder to powder is chosen to assure workability of the solution. For example, about 15 to 35 grams of the organometallic phosphate binding solution may be added to 100 grams of the powder, and the resulting slurry may be milled or mixed by hand until a smooth uniformly mixed slurry or paint results.

This slurry (or paint) is then applied directly to a metal substrate that has been prepared for coating application by substantially removing dirt, oils and contaminants from the surface. Preferably the metal substrate surface is grit blasted using clean aluminum oxide 60 grit sand at 100 psi through a conventional grit blaster. The slurry may be applied by LPHV spraying, dip coating, brushing or other know slurry application techniques.

The resulting coating is then cured. The coating may be thermally cured as follows: heat in an oven until the part attains a temperature of 200° F. for at least 10 minutes; then raise heat until the substrate attains a temperature of 360° F.; then raise heat at a rate of 10°/minute until the substrate attains a temperature of 420° F.; then hold at 420° F. until the substrate sets at this temperature for at least 30 minutes. If the substrate can maintain its integrity or physical properties above 420° F. (216° C.), the part to be coated can be taken to a temperature greater than 420° F. to speed up the heating process.

As an alternative to bulk heating of the entire part, localized heating of the coating layer may employed. For example, lasers or RF heaters may be used to raise the temperature of the coating layer or otherwise supply the energy to accomplish the curing.

Multiple coatings can be applied. Typically a base coat is applied to a thickness of about 0.002 inch. A second coat will typically increase overall coating thickness to 0.010 inch thickness and a 3^{rd} or 4^{th} coating layer will result in a coating of 0.020 inches or 0.5 mm. If the coating layer is smooth and well applied, no grinding or polishing of the coating layer may be necessary, as any surface roughness may be rapidly worn away during use to achieve a smooth sliding layer. However, even though high precision machining may be unnecessary, some degree of rough machining may be needed, for example to meet initial tolerances for cylinder bores and piston ring coatings. Any such machining may be accomplished via conventional honing or grinding techniques to achieve appropriate size.

While it is to be understood that coatings can be applied in any useful thickness, in certain applications, coatings in excess of 0.020 inch may result in undesirable cracking due to escape of trapped water vapor and excessive stresses building up due to mismatch of thermal expansion coefficient between the ceramic coating and the metal substrate. Where these factors are not present or the degree of cracking is not undesirable, coatings in excess of 0.020 inches may be applied.

It is to be appreciated that the use of an organic chrome phosphate as the binding solution allows curing at relatively low temperatures, and as a result is particularly useful for substrates where high curing temperatures are a concern. For metal substrates that can withstand higher curing temperatures, (e.g. up to about 600° F.), the binder may be an inorganic chrome phosphate, such as is obtained by combining chromic acid and phosphoric acid as described in U.S. Pat. No. 4,077,808 to Church.

A suitable inorganic chrome phosphate binder may be prepared by adding 40% by volume of a saturated solution of chromic acid to 60% by volume of an 85% technical grade phosphoric acid solution. The formation of a slurry with an inorganic chrome phosphate binder and subsequent coating of the substrate may proceed as described above with respect to the use of an organic chrome phosphate binder.

When using an inorganic chrome phosphate binder, the resultant coating may be thermally cured as follows: in an over, heat until the part attains a temperature of 200° F. for at least 10 minutes; raise heat until the substrate attains a temperature of 360° F.; then raise heat at a rate of 10°/minute until the substrate attains a temperature of 600° F.; hold at 600° F. until the substrate sets at this temperature for at least 30 minutes. If the substrate can maintain its integrity or physical properties above 600° F., the part to be coated can be taken to a temperature greater than 600° F. to speed up the heating process.

In still other applications, binders that cure at higher temperatures and/or systems that utilize a chemical reaction to bind a coating to a substrate may be employed. For example, a coating including a mixture of iron oxide and titanate powders can be applied using a binder of chromic acid in accordance with U.S. Pat. No. 4,615,913 to Jones et al. The curing temperature for such chromic acid bound coatings is generally about 1050° F.

Other coating techniques may be utilized in addition to or as an alternative to the sol-get techniques described above. For example, the base matrix of iron oxide and iron titanate can be bonded to the substrate via a plasma spray process. In this technique, a powder composition of iron oxide, iron titantate, and any filler materials is prepared as described herein. However, rather than mixing the powder with a liquid binder to create a slurry and then applying the slurry to the substrate, the powder is applied to the substrate via a plasma torch.

As is known in the art, a plasma torch operates by subjecting the powder to extremely high temperatures via a plasma arc such that the powder becomes fluid or molten. The resulting molten material is sprayed directly onto the substrate. Typically, the powder is directed through a plasma arc such that it is liquefied as it is sprayed. When it hits the substrate, the molten material undergoes splat cooling and mechanically binds to the substrate, though the high temperatures involved may result in slight chemical changes to the powder composition upon cooling.

The iron titanate/iron oxide coating applied via a plasma torch may subsequently undergo densification. For densification, a densifying liquid is applied to the coating and then heat cured. Liquids useful as binding liquids (e.g. the chrome phosphate binders described above) may be used as the densifying liquid.

For example, use of a plasma torch creates a relatively soft iron oxide/iron titanate layer bonded to the substrate surface, where the hardness of this layer is typically 400-500 Hᵥ₁₀₀ surface microhardness in Vickers using a 100 gram scale. The densifying liquid described above (i.e. the binding solution in the sol-gel process) serves to fill in open porosity and converts to a chrome phosphate glass upon heating. In forming the glass, the binder/densifier bonds the existing iron oxide/iron titanate matrix more strongly than without the binder. As a result, the coating layer may become harder (approx. 800-900 Hᵥ₁₀₀) and stronger in cohesive bond (e.g. by approximately 60%). As with its use as a liquid binder in a sol-get process, densifying with an organometallic phosphate solution may be performed at lower temperatures and thus is preferred for aluminum and its alloys and other metals that may be damaged by higher cure temperatures.

Both sol-gel and plasma spray techniques involve mechanical application of the powder composition to the substrate with subsequent densification via curing (if desired). Other mechanical or metallurgical applications of a coating to a substrate may be employed, such as laser cladding or laser alloying.

Laser cladding and alloying are being may be used to applying the iron oxide/titanate complex to the surface of a metal substrate with a powerful diode laser. A diode laser has the ability to generate a wide path laser beam (e.g. 24 mm wide) that can provide a means of melting the iron oxide/titanate powders to physically clad a metal substrate with the specific formulated coating. If the laser is directed to melt both the powders and the metal surface, the powders will be alloy into the surface of the metal. In either case, the surface would be relatively dense (i.e no need for subsequent densification) and the incorporation of the powder compounds described herein into the surface of the substrate should impart improved friction and wear characteristics to the cladding or alloyed surface.

Laser cladding and alloying is also referred to as Laser-Induced Surface Improvement (LISI) and is being developed by the University of Tennessee Space Institute (UTSI) to provide high quality surface layers by surface modification. In order to keep the additives attached to the surface of the base material for heating by the laser, the additives (i.e. the iron oxide/titanate powder) may be mixed into a water-based organic binder material and applied to the base material by means of a spray gun or nozzle.

Application techniques that rely on electrochemical deposition of the solids onto the substrate may also be employed to apply the coating compositions described herein, such as electroplating, anodizing, and micro-plasma oxidation.

In anodizing, and micro-plasma oxidation coatings, iron oxide and iron titanate may be introduced into a coating matrix by way of oxygen shared spinels of the base metal cation and the iron oxide (e.g. hematite) or iron titanate (e.g. ilmenite). As known in the art of anodizing and micro-plasma oxidation, the iron compounds would be incorporated into the oxidizing bath and kept suspended in solution by constant mixing of the bath as the anodizing or micro-plasma oxidation process is being performed. The resulting iron oxide/iron titanate spinels are strongly bonded and are part of the final coating layer produced. This technique shows promise for coating aluminum substrates (e.g. cylinder bores of aluminum engines) with a coating of the iron oxide/titanate and another metallic oxide. For example, the iron oxide/titanate may make up about 20-60% with the balance aluminum oxide.

Metal plating involves a slightly different process wherein metals from a metal ion-containing bath are bonded onto a specified substrate. In forming an iron oxide and titanate based coating via metal plating, the iron oxide or titanate particles would be entrapped and bonded within a metal coating matrix generated by a typical metal plating method. In such a process, the size of the iron oxide and iron titanate particles may influence the uniformity of their distribution within the metal plating, and it may be beneficial to use very fine (e.g. less than about 1 μm) particles.

While the powder compositions and weight ratios described herein may generally be used in any useful coating processes, coating layers formed by electro deposition or metal plating techniques may ultimately involve lower weight fractions of iron oxide and titanate than those formed via sol-gel techniques. For example, it is contemplated that iron oxide and/or iron titanate may only constitute from 10% to 40% of the solids in a composite electrodeposited layer whereas they may constitute 60-70% of the solids in a sol-gel produced layer.

After the powder compositions have been deposited on the substrate, the part may be removed and subjected to densification. Densification may proceed as described above with respect to densification after plasma deposition, or densification may be absent.

Laser alloying or laser cladding may also be used to apply an iron oxide and iron titanate powder to a base metal substrate. In such processes, a laser would be used to melt and fuse the iron oxide/iron titanate into the existing metal substrate. It is expected that the resulting coating (laser cladding) or alloyed surface (laser alloying) would have very little open porosity and thus there would be little need or use for subsequent densification.

### EXAMPLES

Various powder compositions were constructed with the components indicated (expressed as weight percent of total powder, −325 mesh) and used to construct composite coatings. The iron oxide and iron titanate were purchased from Chemalloy Company, Inc. The iron titanate came as 200 mesh and was milled to −325 mesh (approx. 15-40 μm) by F.J. Brodmann & Co. LLC. Unless otherwise indicated, the composite coating was formed via the sol-gel technique utilizing the organo metallic phosphate binder described above and in U.S. Pat. No. 5,432,008.

The coatings were applied by spraying to 1 inch diameter test coupons to measure bond strength and to measure microhardness of the coating (expressed on the Vickers scale, 100 gm load). The coatings were applied to a 2 inch roller for friction and wear testing and were tested under lubricating conditions (SAE 30 lubricant, 2 drops/min). Roller speed was 160 m/min and line load contact was approximately 65 MPa with average friction coefficient calculated versus Metco M505 Molyspray.

### Example 1

A powder composed of 80% iron oxide (Fe₂O₃), 20% ZrO₂ (calcium stabilized, TAM ceramics) was prepared and used for testing. The resulting coating demonstrated an average bond strength of 4100 psi, microhardness of 520 Hᵥ₁₀₀, friction coefficient 0.33 avg., and wear rate 0.093 mg/min.

### Example 2

A powder composed of 80% iron titanate (FeTiO₃), 20% ZrO₂ (calcium stabilized, TAM ceramics) was prepared and used for testing. The resulting coating demonstrated an average bond strength of 5500 psi, microhardness of 600 Hᵥ₁₀₀, friction coefficient 0.19 avg., and wear rate 0.325 mg/min.

### Example 3

A powder composed of 40% iron oxide (Fe₂O₃), 40% iron titanate (FeTiO₃), 20% ZrO₂ (calcium stabilized, TAM ceramics) was prepared and used for testing. The resulting coating demonstrated an average bond strength of 7200 psi, microhardness of 680Hᵥ₁₀₀, friction coefficient 0.25 avg., and wear rate 0.015 mg/min. Surprisingly, the observed bond strength, microhardness and wear rate all compare favorably to those of Examples 1 and 2.

### Example 4

A powder composed of 30% iron oxide (Fe₂O₃), 25% iron titanate (FeTiO₃), 18% ZrO₂ (calcium stabilized, TAM ceramics), 12% stainless steel (Amdry PF60), 10% silica (SiO₂), and 5% aluminum oxide (Al₂O₃, Alcoa T-24) was prepared and used for testing. The resulting coating demonstrated an average bond strength of 6500 psi, microhardness of 770 Hᵥ₁₀₀, friction coefficient 0.26 avg., and wear rate 0.022 mg/min. The fine SiO₂ and Al₂O₃ powders were added to provide smoother coating texture and, for the latter, to improve wear rate. The PF60 metal was added for improvements in cohesive bond strength.

### Example 5

A powder composed of 32% iron oxide (Fe₂O₃), 26% iron titanate (FeTiO₃), 25% ZrO₂ (calcium stabilized, TAM ceramics), and 17% micronized Aluminum powder (Alcoa) was prepared and used for testing. The resulting coating demonstrated an average bond strength of 5400 psi and microhardness of 585Hᵥ₁₀₀. The coating was applied to a 1.5 inch diameter thermal shock coupon to test for thermal conductivity, which showed and increase in thermal conductivity. Wear testing was not performed.

### Example 6

A powder composed of 34% iron oxide (Fe₂O₃), 25% iron titanate (FeTiO₃), 25% ZrO₂ (calcium stabilized, TAM ceramics), and 16% stainless steel powder (Amdy PF-60) was prepared and used for testing. The resulting coating demonstrated an average bond strength of 8500 psi, microhardness of 810Hᵥ₁₀₀, friction coefficient 0.21 avg., and wear rate 0.007 mg/min.

### Closure

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding. Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Finally, all publications, patents, and patent applications cited in this specification, including US. Ser. No. 60/718,100 are herein incorporated by reference to the extent not inconsistent with the present disclosure as if each were specifically and individually indicated to be incorporated by reference and set forth in its entirety herein.

What is claimed is:

1. A device comprising a piston ring or cylinder bore having a composite sliding surface layer, wherein the solids in the composite layer include a mixture of finely divided discrete particles of iron oxide and iron titanate in a weight ratio of iron oxide to iron titanate from 1:6 to 3:1.

2. The device of claim 1 wherein the combined weight percent of the iron oxide and iron titanate particles to the total solids is at least 30%.

3. The device of claim 2 wherein the combined weight percent is at least 50%.

4. The device of claim 3 wherein the weight ratio is from 1:6 and 1:1.

5. The device of claim 2 wherein the composite sliding surface layer is formed by at least one of a sol-gel process, an electro deposition process, a plating process, a cladding processes, and an alloying process.

6. The device of claim 5 wherein the particles of iron oxide and iron titanate are alloyed into the surface.

7. The device of claim 5 wherein the particles of iron oxide and iron titanate are alloyed into a metal plating of the surface.

8. The device of claim 5 wherein the particles of iron oxide and iron titanate are clad into the surface.

9. The device of claim 1 wherein the layer is formed via an electrochemical deposition process and a majority of the composite layer is the iron oxide, the iron titanate and one other metallic oxide.

10. The device of claim 9 wherein the layer is formed on an aluminum substrate and at least 80% of the composite layer is aluminum oxide, iron oxide and iron titanate.

11. The device of claim 1 wherein the solids in the composite layer comprise:
10-70% by weight iron oxide;
10-70% by weight iron titanate; and
5-50% by weight ceramic filler.

12. The device of claim 11 wherein the composite layer includes a phosphate glass.

13. The device of claim 12 wherein the ceramic filler includes at least one member selected from the group consisting of zirconium dioxide, silicon dioxide, aluminum oxide, calcium oxide, and clay.

14. The device of claim 12 wherein the solids further include 2-15% by weight of a powdered metal, alloy or combination thereof.

15. The device of claim 2 wherein the iron oxide particles comprise hematite and the ratio of hematite to iron titanate by weight is between 1:2 and 2:1.

16. A device comprising:
a wear surface having a composite sliding surface layer, wherein the composite sliding surface layer comprises hematite and ilmenite in a weight ratio between about 1:6 and 3:1.

17. The device of claim 16 wherein the composite sliding surface layer further comprises ceramic filler wherein the weight ratio of ceramic filler to total hematite and ilmenite is between 1:10 and 1:3.

18. A method comprising:
providing a powder mixture comprising iron oxide and iron titanate in weight ratio of iron oxide to iron titanate from 1:6 to 3:1, wherein the powder mixture is less than 325 mesh; and
forming a composite sliding surface layer on a wear surface with the powder.

19. The method of claim 20 wherein the composite sliding surface layer is formed by at least one of a sol-gel process, an electro deposition process, a plating process, a cladding processes, and an alloying process.

20. The method of claim 18 wherein the weight ratio of iron oxide to iron titanate in the sliding surface layer is between 1:3 and 2:1.

21. The method of claim 20 wherein the sliding surface layer is formed by electrochemical deposition onto an aluminum substrate and a majority of the composite layer is aluminum oxide, iron oxide and iron titanate.

22. The method of claim 20 further comprising forming a slurry with the powder and a chrome phosphate binder.

23. The method of claim 22 further comprising curing the slurry to form a phosphate in the composite layer.

24. The method of claim 23 wherein the composite layer is on a base substrate and the curing is accomplished without raising the temperature of the base substrate above 420° F.
